(19) United States
(12) Patent Application Publication
(10) Pub. No.: US 2025/0342313 A1
(43) Pub. Date: Nov. 6, 2025

(54) Document Parsing Systems And Methods

(71) Applicants: Barak Tsivkin, Newton Center, MA (US); Anthony P. Macciola, Lake Forest, CA (US)

(72) Inventors: Barak Tsivkin, Newton Center, MA (US); Anthony P. Macciola, Lake Forest, CA (US)

(21) Appl. No.: 19/186,450

(22) Filed: Apr. 22, 2025

Related U.S. Application Data
(60) Provisional application No. 63/556,453, filed on Feb. 22, 2024.

(51) Int. Cl. G06F 40/205; G06F 40/58

(52) U.S. Cl. CPC G06F 40/205; G06F 40/58

(57) ABSTRACT

Document parsers, document parsing methods, and products are provided that use Visual Large Language models and/or eForms to generate structural representations to train artificial intelligence used in intelligent document processing. These structural representations are enhanced with the Visual Large Language models with geometry data from the documents and the results are correlated with a training sample. The data set is then curated for errors and omissions and reintegrated into the initial structure of the form. Auto-generated synthetic documents can be used in certain embodiments. Standardized outputs such as eForms and from an Electronic Document Interchange can be used in certain embodiments to enhance efficiency and synchronization of intelligent document processing. A multi-modal transformer-based machine learning model is built that can then be used to create an output in intelligent document processing.

### CROSS-REFERENCE TO RELATED APPLICATIONS

This application claims the benefit of U.S. Provisional Application Ser. No. 63/556,453, filed on Feb. 22, 2024, which is hereby incorporated by reference herein in its entirety.

### FIELD OF THE INVENTION

The invention relates to document parsing systems and methods relating to machine learning.

### BACKGROUND OF THE INVENTION

Machine learning typically requires manual labeling of the documents that are being analyzed. This is normally done by the following:
Gather training documents that represent the types of documents one is likely to encounter;
Manually label the documents by identifying field labels and their associated values;
Build the machine learning model;
Run the model against test documents and measure the accuracy and tolerance of the field parsing results;
Repeat the process until able to achieve the desired fidelity; and
Publish the model and use it in production.

This process of creating and updating document parsing models is neither quick nor easy, and it requires significant human intervention. The training review and model updating process generally requires coding expertise. New and improved systems and methods of creating and updating document parsing models are thus needed.

### SUMMARY OF THE INVENTION

This invention provides document parsers, systems, document parsing methods, and products that use Visual Large Language models and, in some embodiments, eForms, among other things, to generate structural representations of documents that train artificial intelligence and which can be used in intelligent document processing. These structural representations are enhanced with the Visual Large Language models and geometry data from the documents and the results are correlated with a training sample. Auto-generated synthetic documents can also be used. The data set is then curated for errors and omissions and reintegrated into the initial structure of the form. Standardized outputs such as eForms and from an Electronic Document Interchange are used to enhance efficiency and synchronization of intelligent document processing.

Certain preferred embodiments of this invention are designed to aid in the creation of structured form parsers and trained machine learning models. These preferred embodiments make the process of extracting information contained within structured forms quick and easy. These preferred embodiments are designed to make the process a no-code experience that any business user can quickly learn and leverage. These preferred embodiments use artificial intelligence or AI to auto label the documents being analyzed, which is then used to train a transformer.

The document parsing systems and methods of this invention and the associated learning model(s) of the most preferred embodiments use AI to train AI and then enable human review with an opportunity to make any needed corrections before building the final machine learning model. The novelty is directly related to steps 2, 3, 4 and 5 (the blocks in order from top to bottom) as seen in FIG. 2, as an example.

Certain of the most preferred embodiments of this invention use AI to train AI references in this approach to using Visual Large Language Model (VLLM) at design time (which can be slow and unpredictable) to bootstrap and simplify the labelling process. These embodiments also use the output training data set of the simplified labelling process to train a multi-modal transformer that will be used at runtime.

Using trained document understanding transformer models at runtime allows these preferred embodiments to deliver much higher performance and fidelity than the VLLM used in design time. It also allows these preferred embodiments to generate the needed field geometry and prediction confidence levels needed to enable runtime quality control and review.

Certain highly preferred embodiments of this invention use eForm as a method for delivering synthetically generated training document samples, test document samples, and anonymized demo documents.

Certain preferred embodiments of this invention can be used to simplify and automate document processing, including simplifying and automating the training of document parsers, document parsing methods, and parsing models, and also simplifying information delivery, in intelligent document processing.

Certain embodiments of this invention use artificial intelligence or “AI” and different steps, such as to automatically label and parse the documents being analyzed, and then train models. These embodiments aid in the creation of structured form parsers and trained machine learning models. These embodiments make the process of extracting information from documents faster than typical processes of document processing. These embodiments are designed to make the process a no-manual-coding experience that users can quickly learn and leverage.

Certain of these embodiments are document parsers, document parsing methods, and associated machine learning models using AI to train AI and then enabling human review to make any needed corrections before building the final machine learning model.

Preferred steps in certain of these embodiments are to 1. load training data set (e.g., documents) for a designated project; 2. generate initial form structure for the data set (e.g., using open-source Visual Large Language models to generate structural representations of the input forms); 3. enriching the form structure with geometry from the data set and generating a structural representation (e.g., extending generated structural representations from Visual Large Language model learning with geometry); 4. visualize structural representations (e.g., visualize results by correlating structural representations and geometry with the training sample); 5. curating errors and omissions (e.g., curate errors and omissions of generated structural representations); and 6. train a machine learning model with the curated structural representations (e.g., build, benchmark, and deploy the curated model using MLOps). The machine learning model can then be used in intelligent document processing. In some embodiments, synthetic documents are auto-generated and used for the training.

Certain embodiments of this invention use AI to train AI using Visual Large Language models at design time to enhance its efficiency, which can otherwise be slow and unpredictable. Such use can bootstrap and simplify the document labelling process. Furthermore, using the output training data set of the simplified labelling process to train a multi-modal transformer model that will be used at runtime can also enhance the efficiency.

Using such a trained document-understanding transformer model at runtime allows certain embodiments of this invention to deliver much higher performance and fidelity than the Visual Large Language models used in the design time. It also allows certain embodiments of this invention to generate the needed/useful field geometry and predict confidence levels needed to enable runtime quality control and review.

Certain preferred embodiments of this invention use eForms to assist in the training of AI in intelligent document processing. These embodiments have advantages, including the advantage of simplifying the training of parsing models used in intelligent document processing compared to typical solutions.

Certain embodiments of this invention use eForms to deliver information to a host in intelligent document processing. These embodiments have advantages, including the advantage of simplifying interoperability between components of document processing using an established standard.

Certain embodiments of this invention use existing Electronic Data Interchange or “EDI” standards to deliver information to a host in intelligent document processing. These embodiments also have advantages, including the advantage of simplifying interoperability between components used in the document processing using an established standard.

Certain preferred embodiments of this invention use eForms as the standard method for delivering synthetically generated training document samples and anonymized demo documents.

### Certain Aspects Of Model Training

Certain embodiments of this invention perform model training that reads the field structure contained within eForms, including labels, values, associated geometry, and if available, field valuation rules, etc. These embodiments use this information to generate the structure needed to train a parsing model. Once the user is confident the models are generating the fidelity needed for production use, these embodiments can provide standard Machine Learning Operations or “MLOps” capabilities, allowing the user to publish the needed models for processing the target form.

In certain preferred embodiments, the field structure contained within the eForm is read (label-value pairs, tables and associated geometry, and if available, field validation rules, etc.) and this information is used to generate the structure needed to train a visual language model that can be used to parse information contained in an input form document.

Once the eForm structure is analyzed and absorbed, certain embodiments of this invention, using live samples, allow a user to fine-tune and curate a parsing model and auto-update a master classification model. Once satisfied that the models are generating acceptable fidelity needed for production use, these embodiments can provide MLOps capabilites that allow the user to publish the needed models for processing the target form.

In certain preferred embodiments, once the eForm structure in analyzed and absorbed, using several additional line samples, the user can curate the dataset and subsequently fine-tune a visual language model and auto-update a master classification model. Once the user is confident the models are generating the fidelity needed for production use, these preferred embodiments will provide standard MLOps capabilities that allow the user to publish the needed visual language models for processing the target document.

### Standard Information Delivery (SID)—PDF eForm

Certain embodiments of this invention standardize information delivery in a form such as a PDF eForm. Once deployed, these embodiments can be configured to generate output of a certain form, such as JavaScript Object Notation or “JSON” output or an eForm output. In certain preferred embodiments, the models are configured to generate JSON output where the JSON results are embedded in an eForm using the eForm structure, or the original form structure, essentially auto-filling the (e.g., eForm or original form) fields with the information that was parsed from the live form, resulting in a standard output mechanism. In these embodiments, any application that can read an eForm (e.g., PDF eForm) or other form will be able to read and take action on a document processed with no upfront integration.

In certain preferred embodiments, fillable eForm output is not limited to the models (e.g., visual language models) that were trained on eForms. The fillable eForm output is independent from how the model (e.g., visual language model) was trained.

### Certain Aspects Of Standard Information Delivery (SID)—EDI

Certain embodiments of this invention standardize information delivery in an EDI output. Once deployed, these embodiments (including visual language models that are built) can be configured to generate an EDI output transaction after parsing a document. As one example, these embodiments can process Explanations of Benefit and output EDI 835 Electronic Remittance Advice or “ERA” transactions. In another example, these embodiments can process invoices and output EDI 810 transactions. This approach is similar to the eForm approach described above. Any application capable of reading the specific EDI stream can process the transaction with no upfront integration.

### Certain Aspects Of Generated Synthetic Documents

Certain preferred embodiments of this invention auto-generate synthetic documents. An admin feature can specify how may synthetic documents are to be created. These embodiments then create the desired number of synthetic documents using SID and auto-filling fields with anonymized field information. This eliminates (or reduces) PII risk (e.g., personally identifiable information risks when using sensitive information). Synthetic documents can be used to bolster the training and test document sets and can also be used for marketing purposes by providing demonstration documents.

In these preferred embodiments, there are at least two methods to generate synthetic documents. One is to fill the fields of the form being used with synthetic data using corresponding eForm structure. Another is to fill in the fields of the form, applying AI to get more realistic data that is close to the actual documents while still preserving anonymization.

Advantages of this invention are identified herein and/or will be apparent to a person skilled in the art. These advantages of certain embodiments may include speed of document processing, automation using AI, and standardized output that reduces the amount of integration and synchronization needed. Additional advantages will be apparent to a person skilled in the art.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims

In the description set forth herein, the drawings are intended to illustrate major features of exemplary embodiments in a diagrammatic manner. The drawings are not intended to depict every feature of every implementation.

In the description set forth herein, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

### BRIEF DESCRIPTION OF DRAWINGS

FIG. 1 shows a diagram of the machine learning process from prior art.

FIG. 2 shows a diagram of the machine learning process for Certain preferred embodiments.

### DETAILED DESCRIPTION OF THE INVENTION

Document parsing systems and methods are provided that in certain preferred embodiments use visual large language models to generate structural representations of the input forms. These structural representations are then extended from the visual large language models with geometry and the results are correlated with the training sample. The data set is then curated for errors and omissions and reintegrated into the initial structure of the form.

The term eForm as used herein is an electronic version of a form. It can replace the need for a paper form and in some embodiments it captures, validates, and submits data to a recipient for processing, allowing data to be transmitted electronically. Such a form can be in the format of a PDF document, for example.

EDI as used herein provides a standardized format for the exchange of electronic documents between parties (e.g., businesses, trading partners, individuals). Common EDI standards include EDIFACT, Tradacoms, ANSI X12, EANCOM, and XML, among others.

JSON as used herein is a standard text-based format for representing structured data based on JavaScript object syntax. It is a common format used for transmitting data in web applications (e.g., sending data from a server to a client so it can be displayed on a web page).

MLOps as used herein are sets of practices that automate and simplify machine learning workflows and deployments. These sets of practices are focused on streamlining the process of taking machine learning models to production, and then maintaining and monitoring those processes. Machine learning and AI are core capabilities for preferred embodiments of this invention.

MLOps sets of practices can include data ingest, exploratory data analysis, data prep and feature engineering, model training, model tuning, model deployment, model monitoring, model retraining, explainability, and others. MLOps as used herein may add efficiency such as faster model development, higher quality models, and faster deployment and production. MLOps may also enable scalability and management of multiple models and enable transparency and faster response to requests.

Specific MLOps practices that can be applied to this invention include exploratory data analysis to explore, share and prep data for machine learning by creating datasets, tables and visualizations. Data prep and feature engineering can also be applied, which may include transforming, aggregating and de-duplicating data to created refined features that are visible and shareable. Model training and tuning can be used to improve model performance (e.g., scikitlearn, hyperopt, AutoML). Model review and governance can also be used to include tracking model lineage and versions and managing model artifacts and transitions. Model inference and serving can be used and can include managing model refresh, inference request times, and production specific tasks in testing. Model deployment and monitoring can be used and can include automating permissions and cluster creation to produce models. Automated model retraining can be used and it can include creating alerts and automation to correct model drift.

A REST API as used herein is an application programming interface or “API” that conforms design principles of the representational state transfer or “REST”software architectural style that is being used. It defines a set of constraints for how the architecture should behave.

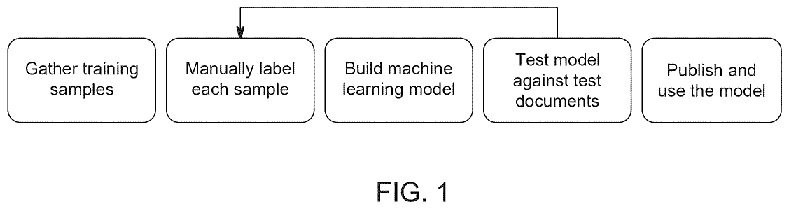

These systems and methods have several advantages over the prior art (e.g., FIG. 1). They can make the process of creating and updating document parsing models both quick and easy, and require less human intervention. The training review and model updating process may not require coding expertise in certain embodiments. New and improved systems and methods of creating and updating document parsing models are thus provided.

In a particularly preferred embodiment of this invention, (a) a document sample set is loaded and a data set created, (b) an open source visual large language model is applied to the document pages to generate structural representations of the input forms, and/or, a PDF eForm or other existing electronic form, is used to generate the structural representations, (c) extended structural representations from visual large language models with geometry are generated that identify and parse various structures within the documents, (d) the results are visualized by correlating structural representations and geometry with the sample, (e) errors and omissions of the generated structural representations are curated, and (f) machine learning operations are applied and a model that can be used in production is built, benchmarked and deployed (e.g., with additional documents and/or with the original set). In certain preferred embodiments, (b) through (e) are part of a curating system/process.

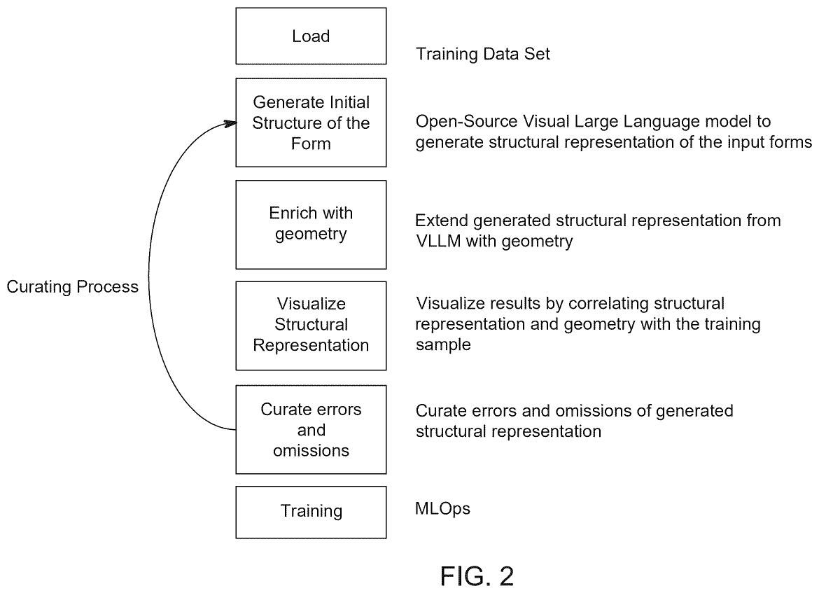

Certain preferred embodiments of this invention are broken down into the following steps (e.g., FIG. 2):

1. The user starts the process by creating a project and loading a set of sample documents (preferably 20+ sample documents, but the process can start with as little as 5 sample documents).

2. Starting with the first sample and moving through each sample until they've reviewed the entire sample set.

3. These preferred embodiments automatically analyze the page using a VLLM (and/or PDF eForm) and generate the associated structural representation of the form's page. These preferred embodiments integrated support for a variety of vision large language models and allow the user to select the language model they would prefer to use for learning.

4. These preferred embodiments then automatically generate the structural relationships contained within the page and all associated geometry wherein a multi-pass architecture enabling it to analyze documents using multiple language models and multi-model transformers to identify and parse a variety of structures contained within the document (e.g., key value pairs, OMR zones, tables, signatures, and raw and/or summarized narratives, abstracts, provisions, and clauses).

5. When possible, these preferred embodiments automatically generate the structural relationships contained within the page and all associated geometry.

6. These preferred embodiments then use the geometry generated in step 5 to visualize the structural breakdown and associated relationships generated in step 3 to allow a human to review the analysis.

7. These preferred embodiments automatically generate overall document level and field level confidence levels.

8. These preferred embodiments enable a human operator to confirm the structural analysis breakdown and the geometry generated in steps 3, 4, and 5 to graphically correct any prediction mistakes and/or assignments. As part of the review process, these preferred embodiments provide needed learning analytics metrics, which are needed to help determine overall model fidelity and accuracy.

9. The user then repeats steps 2 through 8 for each sample training document until complete.

10. The user then directs these preferred embodiments to build a lightweight multi-modal transformer-based machine learning model associated with the project name, that can then be used in production.

11. Creating a project for a specific document type will result in a trained ML or machine learning model specific to the document type based on the training samples used for building the model. The creation of a model results in two separate training activities:

a. Training an ML model for the purposes of parsing information from the document and returning results in a JSON format or similar text-based format for representing and exchanging structured data to the host.

b. Training an ML model for the purposes of classifying the document at run-time. Training the ML model for the purposes of classification allows the host to identify the document parsing in an architectural style for an application programming interface (e.g., REST APIs) without having to specify document type or the type of ML parsing model to use. Having been silently trained as a result of building the ML parsing model, the architectural style for API (e.g., REST API) will first invoke the trained ML classification model to determine document type and will auto-load the appropriate ML parsing model, thus eliminating the step/process typically associated with having to train a document classifier.

Certain of the most preferred embodiments use AI to train AI references the approach to using VLLMs/LLMs at design time (which can be slow and unpredictable) to bootstrap and simplify the labeling process, and using the output of the simplified labeling process to train a multi-modal transformer that will be used at runtime. PDF eForms can also be used.

Using trained multi-modal transformer technology at runtime allows certain preferred embodiments to deliver much higher performance and fidelity than the VLLM/LLM used in design time. It also allows embodiments of this invention to generate the needed field geometry and confidence levels needed to enable runtime quality control and review.

The subject matter of this disclosure is now described with reference to the following examples. These examples are provided for the purpose of illustration only, and the subject matter is not limited to these examples, but rather encompasses all variations which are evident as a result of the teaching provided herein.

### EXAMPLES

In these examples, the following steps can be performed individually or combined together.

1. The user starts the process by creating a project and loading a set of sample documents (preferably 20 or more sample documents, but the process can start with as little as 5 sample documents).

2. Starting with the first sample and moving through each sample until the entire sample set has been reviewed.

3a. If an electronic form (e.g., PDF eform or any other type of electronic form artifact containing the overall structure of the document) exists that is representative of the form to be trained, certain embodiments of this invention use the electronic form as training input, and parse the structure (labels, values, geometry, validation rules, etc.) from the electronic form and uses the structural information as input for the training process.

3b. If there is no electronic form available as input for the training process, certain embodiments of this invention analyze each page using a Visual Large Language model and generate the associated structural representation of the form.

These embodiments of this step 3. provide integrated support for a variety of Visual Large Language models and allows the user to select the language model they would prefer to use for learning.

4. Automatically generating the structural relationships contained within the page and all associated geometry wherein a multi-pass architecture enables the analysis of documents using multiple language models and multi-model transformer model to identify and parse a variety of structures contained within the document (e.g., key value pairs, Optical Mark Recognition or “OMR” zones, tables, signatures, and raw and/or summarized narratives, abstracts, provisions, and clauses, etc.).

5. When possible and/or necessary, automatically generating the structural relationships contained within the page and all associated geometry.

6. Using the geometry generated in step 5. to visualize the structural breakdown and associated relationships generated in step 3. to allow a human to review the analysis.

7. Automatically generating overall document level and field level confidence levels.

8. Enabling a human operator to confirm the structural analysis breakdown and the geometry generated in steps 3., 4., and 5. to graphically correct any prediction mistakes and/or assignments. As part of the review process, providing needed learning analytics metrics, which are needed to help determine overall model fidelity and accuracy.

9. The user then repeats steps 2. through 7. for each sample training document until complete.

10. The user then directs the parser to build a lightweight multi-modal transformer-based machine learning model associated with the project name, which can then be used in production (i.e., the intelligent document processing).

11. Creating a project for a specific document type will result in a trained machine learning model specific to the document type based on the training samples used for building the model. This will often times be augmented by the multi-pass architecture enabling the analyzing of documents using multiple models to identify and parse a variety of structures contained within the document type based on the training samples used for building the model. The creation of a model results in two separate training activities:

a. Training a machine learning model for the purposes of parsing information from the document and returning JSON or other format (e.g., eForm) results to the host.

b. Training a machine learning model for the purposes of classifying the document at runtime. Training the machine learning model for the purposes of classification allows the host to call the document parsing REST APIs without having to specify document type or the type of machine learning parsing model to use. Having been silently trained as a result of building the machine learning parsing model, the REST API will first invoke the trained machine classification model to determine document type and will auto-load the appropriate machine learning parsing model, thus eliminating the step/process typically associated with having to train a document classifier.

These embodiments use AI to train AI, which references the approach to using Visual Large Language models/Large Language models at design time (which can be slow and unpredictable) to bootstrap and simplify the labeling process, and using the output of the simplified labelling process to train multi-modal transformer models that will be used at runtime.

Using trained multi-modal transformer models at runtime allows these embodiments to deliver much higher performance and fidelity than the Visual Large Language model/Large Language model used in design time. It also allows embodiments of this invention to generate the needed field geometry and confidence levels needed to enable runtime quality control and review.

### Certain Uses Of eForms

In particularly preferred embodiments of this invention, PDF eForms are used as inputs to train AI and ultimately build multi-model models that can parse paper of flat digital versions of the forms.

In addition, in certain preferred embodiments of this invention, PDF eForms are used as outputs where such eForms are automatically created and filled in, essentially creating an eForm from a live paper version of a form.

### Certain Uses Of Visual Language Models And Synthetic Information And Data

In model training, a visual language model can be used to parse information contained in an input form document. In certain embodiments, a user can curate and subsequently fine-tune a visual language model. In certain embodiments, a user can publish the needed visual language models for processing the target document. However, fillable eForm output may not be limited to the visual language models that were trained on the eForms in some embodiments.

In certain embodiments, synthetic documents are used to avoid PII risks. These embodiments can auto generate the synthetic documents in a number selected by the user or the embodiment itself. Synthetic documents can be used to enhance training and in test document sets and can be generated in certain embodiments by filling the fields in of the form being used with synthetic data using the applicable eForm structure with or without the use of AI to obtain more realistic data.

In certain preferred embodiments, eForms are used as a standard method for delivering synthetically generated training samples, test document samples, and anonymized demo documents.

### Particular Applications To Computer Devices

A document parser of this invention may be comprised of one or more computing devices with memory and readable media, including the instructions for intelligent document processing (e.g., document intake, analysis, AI training, model creation, model analysis and review, etc.).

A system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

We claim:

1. A method of document parsing, the method comprising:
a) loading a set of sample documents;
b) analyzing each sample document using multiple Visual Large Language models and generating an associated structural representation for each sample document containing geometry information;
c) presenting the structural representations to a user to review the analysis and confirm the structural representations;
d) generating document level and field level confidence levels for the set of sample documents;
e) repeating b) through d) to train the Visual Large Language models;
f) building a multi-modal transformer-based machine learning model; and
g) using the multi-modal transformer-based machine learning model to output data for use in the intelligent document processing.

2. The method of claim 1, wherein b) an eForm is generated.

3. The method of claim 1, wherein the output to the intelligent document processing comprises an eForm.

4. The method of claim 1, wherein the output to the intelligent document processing comprises an Electronic Data Interchange form.

5. The method of claim 1, wherein the sample documents comprise synthetic documents that are auto-generated.

6. The method of claim 1, wherein the sample documents comprise synthetic documents that are auto-generated using AI.

7. A method of document parsing for use in intelligent document processing, the method comprising:
a) loading training set data;
b) generating initial form structure from the training data using Visual Large Language models;
c) enriching the form structure with geometry information using the Visual Large Language models;
d) visualizing the form structure with a structural representation;
e) curating errors and omissions of the structural representation; and
f) training a machine learning model for generating output for use in the intelligent document processing.

8. The method of claim 7, wherein b) an eForm is generated.

9. The method of claim 7, wherein the output to the intelligent document processing comprises an eForm.

10. The method of claim 7, wherein the output to the intelligent document processing comprises an Electronic Data Interchange form.

11. The method of claim 7, wherein the sample documents comprise synthetic documents that are auto-generated.

12. The method of claim 7, wherein the sample documents comprise synthetic documents that are auto-generated using AI.

13. A method of document parsing, the method comprising:
a) creating a project and loading a sample set of documents;
b) reviewing each document in the sample set;
c) generating an electronic form of each document;
d) analyzing the electronic form of each document using a Visual Large Language model;
e) generating a structural representation of each electronic form;
f) visualizing the structural representation of each electronic form;
g) generating overall document level and field level confidence levels for each electronic form;
h) reviewing the document level and filed level confidence levels;
i) repeating d) through h) for each document in the set of documents;
j. building a multi-modal transformer-based machine learning model that can then be used to provide output for use in intelligent document processing.

14. The method of claim 13, wherein in c) an eForm is generated. The method of claim 13, wherein the output to the intelligent document processing comprises an eForm.

15. The method of claim 13, wherein the output to the intelligent document processing comprises an Electronic Data Interchange form.

16. The method of claim 13, wherein the sample documents comprise synthetic documents that are auto-generated.

17. The method of claim 13, wherein the sample documents comprise synthetic documents that are auto-generated using AI.

18. The methods of claims 1, 7 and 13 wherein analyzing steps are performed with multi-pass architecture enabling the analyzing of documents using multiple models to identify and parse a variety of structures contained within the document type based on the training samples used for building the model.

19. A document parser comprising:
a) a computer device comprising an input for loading a set of sample documents;
b) the computer device further comprising a processor for i) analyzing each sample document using multiple Visual Large Language models and generating an associated structural representation for each sample document containing geometry information; ii) presenting the structural representations to a user to review the analysis and confirm the structural representations; iii) generating document level and field level confidence levels for the set of sample documents; iv) repeating i) through iii) to train the Visual Large Language models; v) building a multi-modal transformer-based machine learning model; and vi) using the multi-modal transformer-based machine learning model to output data for use in intelligent document processing.

20. The method of claim 19, wherein in i) an eForm is generated.

21. The document parser of claim 19, wherein the output to the intelligent document processing comprises an eForm.

22. The document parser of claim 19, wherein the output to the intelligent document processing comprises an Electronic Data Interchange form.

23. The method of claim 19, wherein the sample documents comprise synthetic documents that are auto-generated.

24. The method of claim 19, wherein the sample documents comprise synthetic documents that are auto-generated using AI.

25. A document parser for use in intelligent document processing comprising:
a) a computer device comprising an input for loading training set data;
b) the computer device further a processor for i) generating initial form structure from the training data using Visual Large Language models; ii) enriching the form structure with geometry information using the Visual Large Language models; iii) visualizing the form structure with a structural representation; iv) curating errors and omissions of the structural representation; and v) training a machine learning model for use in creating an output to the intelligent document processing.

26. The method of claim 25, wherein the output to the intelligent document processing comprises an eForm.

27. The method of claim 25, wherein the output to the intelligent document processing comprises an Electronic Data Interchange form.

28. A document parser comprising:
a)) a computer device comprising an input for loading training set data;
b) the computer device further a processor for i) creating a project and loading a sample set of documents; ii) reviewing each document in the sample set; iii) generating an electronic form of each document; iv) analyzing the electronic form of each document using a Visual Large Language model; v) generating a structural representation of each electronic form; vi) visualizing the structural representation of each electronic form; vii) generating overall document level and field level confidence levels for each electronic form; viii) reviewing the document level and filed level confidence levels; ix) repeating iv) through viii); and x) building a multi-modal transformer-based machine learning model that can then be used to create an output in intelligent document processing.

29. The document parser of claim 28, wherein the output to the intelligent document processing comprises an eForm.

30. The document parser of claim 28, wherein the output to the intelligent document processing comprises an Electronic Data Interchange form.

31. The method of claim 28, wherein the sample documents comprise synthetic documents that are auto-generated.

32. The method of claim 28, wherein the sample documents comprise synthetic documents that are auto-generated using AI.

33. The document parser of claims 19, 25 and 28, wherein analyzing steps are performed with multi-pass architecture enabling the analyzing of documents using multiple models to identify and parse a variety of structures contained within the document type based on the training samples used for building the model.
